(19) United States
(12) Patent Application Publication
(10) Pub. No.: US 2010/0299893 A1
(43) Pub. Date: Dec. 2, 2010

(54) Double locking snap hook device

(76) Inventor: Feng-Chia Liang, Taichung (TW)

Correspondence Address: CHARLES E. BAXLEY, ESQUIRE, 90 JOHN STREET, SUITE 309, NEW YORK, NY, 10038, US

(21) Appl. No.: 12/455,468

(22) Filed: Jun. 2, 2009

(51) Int. Cl. F16B 45/02

(52) U.S. Cl. 24/599.5

(57) ABSTRACT

A snap hook device includes a hook member having a hook throat opening formed by a hook portion and a shank, a hinged gate pivotally coupled to the shank and biased to openably close the hook throat opening, a latch member pivotally coupled to the shank with a pivot axle and biased to openably close a compartment of the hook member, the latch member includes an anchor member for engaging with a lock member of the hinged gate and for locking the hinged gate to the hook member, and to prevent the hinged gate lo from being depressed to open the hook throat opening before the anchor member of the latch member is disengaged from the hinged gate.

### BACKGROUND OF THE INVENTION

1. Field of the Invention

The present invention relates to a safety snap hook device, and more particularly to a safety snap hook device including a double locking structure for safely locking the hinged gate of the snap hook device and for preventing the hinged gate of the snap hook device from being opened inadvertently and for allowing the snap hook device to be easily manufactured and operated.

2. Description of the Prior Art

Typical snap hook devices comprise a hinged gate or latch member pivotally coupled to a hook body for openably closing a hook throat opening. However, the hinged gate or latch member may be depressed and actuated to open the hook throat opening inadvertently, and the strap or the belt connection will also be disengaged from the hook throat opening of the hook body inadvertently.

For safely securing or locking the strap or the belt connection to the hook body, a safety latching mechanism or locking structure may be provided and attached or coupled to the hook body for safely locking the latching mechanism or locking structure to the hook body and for preventing the snap hook from being opened inadvertently.

For example, U.S. Pat. No. 5,608,953 to Petzl et al., U.S. Pat. No. 5,791,025 to Maurice et al., U.S. Pat. No. 6,161,264 to Choate, and U.S. Pat. No. 6,588,076 to Choate disclose four of the typical snap hook devices each also comprising a finger or gate pivotally coupled to a hook body for openably closing a hook throat opening, and a safety latching mechanism or locking structure attached or coupled to the hook body for safely locking the latching mechanism or locking structure to the hook body and for preventing the snap hook from being opened inadvertently.

However, the safety latching mechanisms or locking structures normally include a tiny size or dimension or structure that may not be easily operated by the user, such that the typical snap hooks may not be easily operated by the user.

The present invention has arisen to mitigate and/or obviate the afore-described disadvantages of the conventional safety snap hook devices.

### SUMMARY OF THE INVENTION

The primary objective of the present invention is to provide a safety snap hook device including a double locking structure for safely locking the hinged gate of the snap hook device and for preventing the hinged gate of the snap hook device from being opened inadvertently and for allowing the snap hook device to be easily manufactured and operated.

In accordance with one aspect of the invention, there is provided a snap hook device comprising a hook member including a hook throat opening formed therein and defined by a hook portion and a shank, and including a compartment formed therein and located opposite to the hook throat opening of the hook member, a hinged gate pivotally coupled to the shank of the hook member with a pivot pin for openably closing the hook throat opening of the hook member, a first spring biasing member disposed between the hinged gate and the shank of the hook member for biasing and forcing the hinged gate to close the hook throat opening of the hook member, and arranged to allow the hook throat opening of the hook member to be selectively opened when the hinged gate is depressed onto the spring biasing member and forced toward the shank of the hook member, a latch member pivotally coupled to the shank of the hook member with a pivot axle for openably closing the compartment of the hook member, the latch member including an anchor member extended therefrom, and a second spring biasing member disposed between the latch member and the shank of the hook member for biasing and forcing the latch member to close the compartment of the hook member, and arranged for allowing the compartment of the hook member to be selectively opened when the latch member is depressed onto the spring biasing member and forced toward the shank of the hook member, the second spring biasing member being provided for biasing and forcing the anchor member of the latch member to engage with the hinged gate and to lock the hinged gate to the hook member, and to prevent the hinged gate from being depressed and actuated and forced toward the shank of the hook member and to prevent the hook throat opening of the hook member from being opened inadvertently before the anchor member of the latch member is disengaged from the hinged gate.

The hinged gate includes a lock member extended therefrom for selectively engaging with the anchor member of the latch member and for selectively locking or securing the hinged gate to the hook member when the lock member of the hinged gate is aligned and contacted and engaged with the anchor member of the latch member.

The lock member of the hinged gate and the anchor member of the latch member and the pivot axle are aligned with each other, and the anchor member of the latch member is disposed between the lock member of the hinged gate and the pivot axle for locking the hinged gate to the hook member.

The hook member includes a stem extended upwardly from the shank, and an eye device rotatably coupled to the stem of the hook member for allowing the hook member to be easily and quickly hung or coupled to the other objects or straps or belt connections with the eye device.

The eye device includes a loop member and a base ring provided on the loop member, and the base ring includes a bore formed therein for rotatably receiving and engaging with the stem of the hook member and for rotatably coupling the base ring and the loop member to the stem of the hook member.

The eye device includes a ball bearing device disposed between the base ring and the stem of the hook member for rotatably coupling the loop member of the eye device to the stem of the hook member.

The eye device includes a gasket engaged into the bore of the base ring and engaged with the ball bearing device for anchoring the ball bearing device between the stem of the hook member and the base ring of the eye device.

The eye device includes a spring ring having an opening formed therein for receiving and engaging with the stem of the hook member, and having a peripheral indicating layer provided around the spring ring, and the indicating layer includes a high-visibility color different from that of the gasket and offered as an increased visual aid to verify whether the spring ring has been compressed or not.

The eye device includes a lock nut engaged with or riveted or secured to the stem and engaged with the spring ring for maintaining the spring ring in an upwardly extended and inclined status.

The hook member includes a peripheral indicating layer provided around the stem and covered and shielded by the base ring before the spring ring is compressed, and the peripheral indicating layer of the hook member is exposed and to be seen by a user when the spring ring is compressed.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a safety snap hook device in accordance with the present invention;

FIG. 2 is a perspective view of the safety snap hook device;

FIG. 3 is a partial cross sectional view of the safety snap hook device;

FIG. 4 is a further partial cross sectional view of the safety snap hook device; and

FIG. 5 is a plan schematic view illustrating the operation of the safety snap hook device.

### DETAILED DESCRIPTION OF THE PREFERRED EMBODIMENT

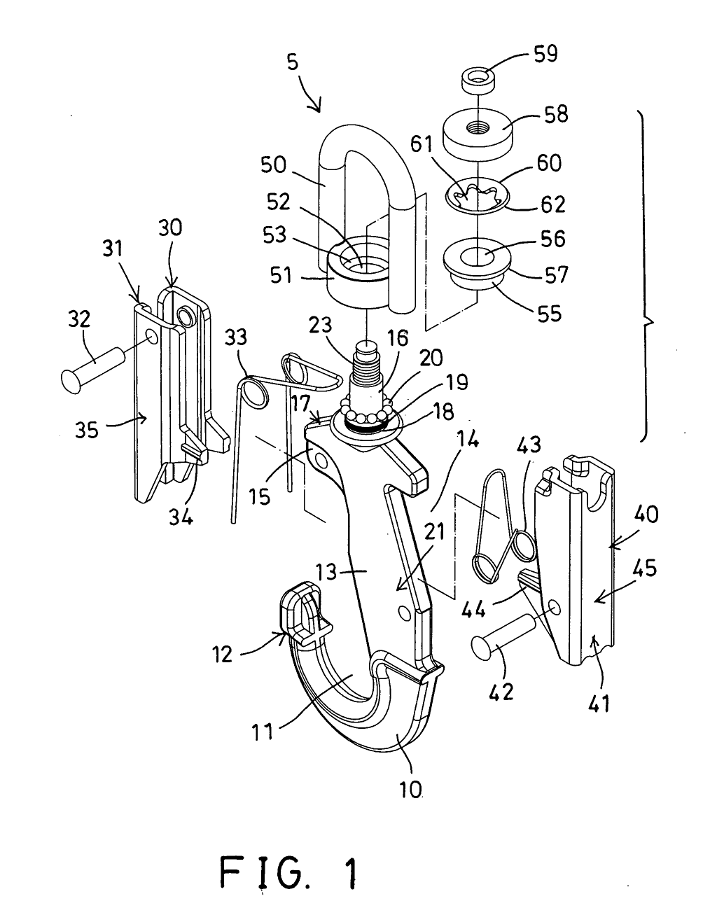

Referring to the drawings, and initially to FIGS. 1-4, a safety snap hook device in accordance with the present invention comprises a hook member 10 including a hook throat opening 11 formed therein and formed or defined by a hook portion 12, and including a shank 13 having a notch or compartment 14 formed therein and located opposite to the hook throat opening 11 and the hook portion 12, and including an ear 15 formed or provided in the upper or middle portion of the shank 13, and including a stem 16 extended upwardly from the upper portion 17 of the shank 13, and including a circular or peripheral indicating layer 18 formed or provided around the root portion of the stem 16.

The indicating layer 18 of the stem 16 includes a high-visibility color different from that of the shank 13 and the stem 16 and offered as an increased visual aid to verify whether the indicating layer 18 of the stem 16 is exposed or not, which will be described in further details hereinafter. The hook member 10 may further include a peripheral recess or shoulder 19 also formed or provided around the root portion of the stem 16 and located slightly above the indicating layer 18 for engaging with a ball bearing device 20 therein, and may further include a threaded segment 23 formed or provided on the upper portion of the stem 16.

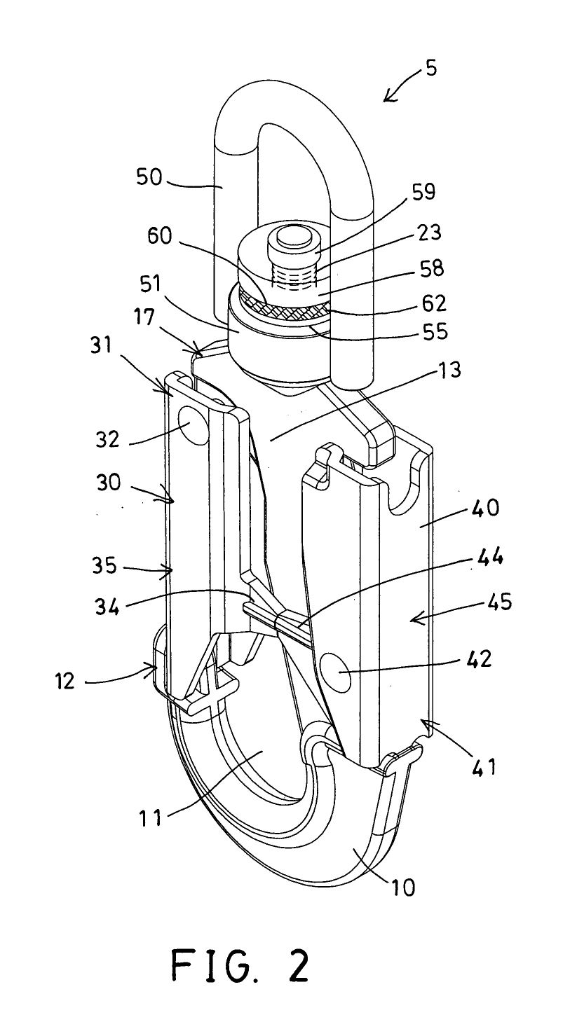

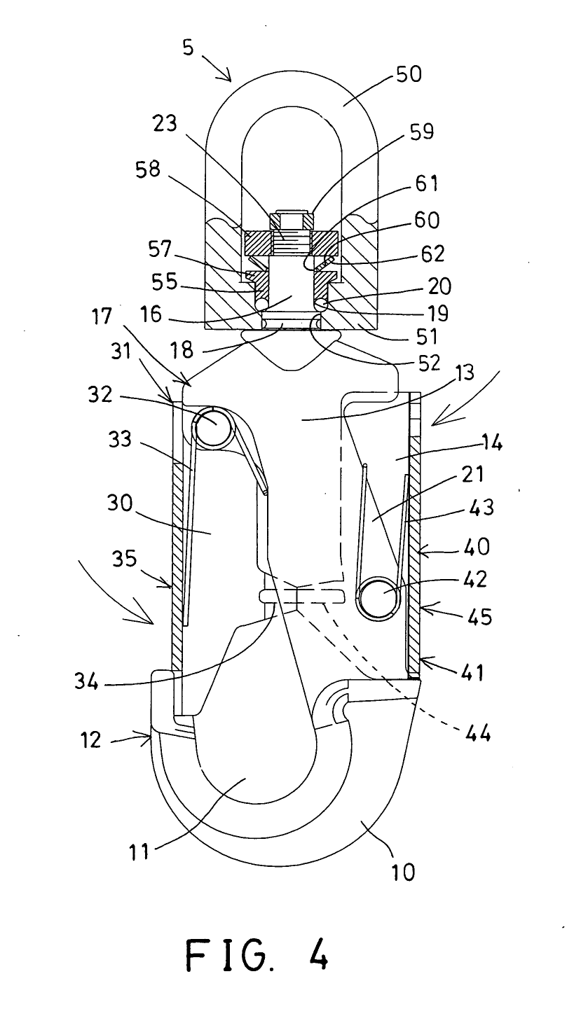

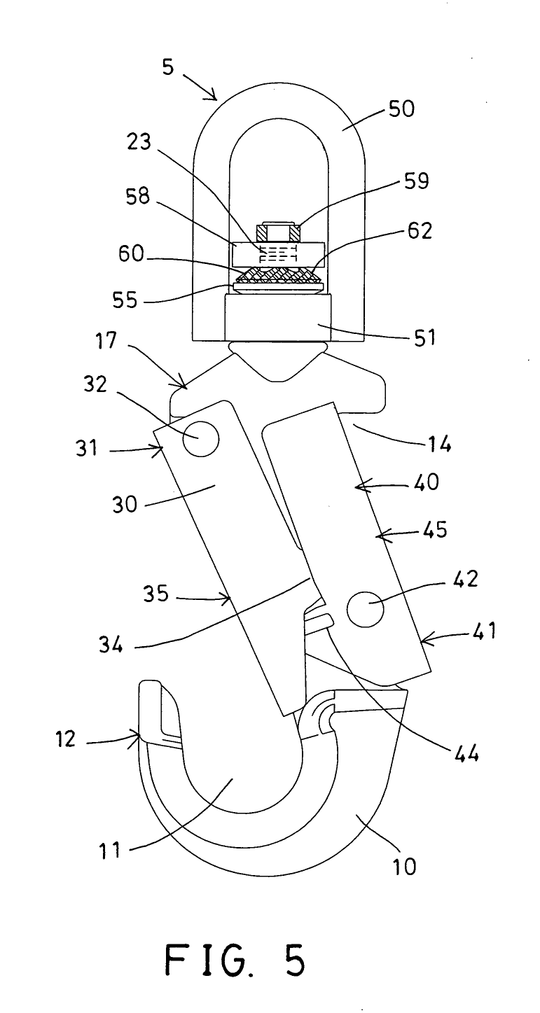

A finger or hinged gate 30 includes an upper portion or one end 31 pivotally coupled to the hook member 10, such as pivotally coupled to the ear 15 or the upper portion 17 of the shank 13 with a pivot pin 32 for openably closing the hook throat opening 11 of the hook member 10 (FIGS. 2-5), a spring biasing member 33 is attached or engaged onto the pivot pin 32 and/or disposed between the hinged gate 30 and the shank 13 or the hook member 10 for biasing or forcing the hinged gate 30 to block or to close the hook throat opening 11 of the hook member 10 (FIG. 4), and arranged for allowing the hook throat opening 11 of the hook member 10 to be selectively opened when the hinged gate 30 is depressed onto the spring biasing member 33 and forced or moved toward the shank 13 or the hook member 10 (FIG. 5). The hinged gate 30 includes an extension or lock member 34 extended therefrom, such as extended from the lower or middle portion 35 thereof.

A finger or handle or latch member 40 includes a lower portion or one end 41 pivotally coupled to the hook member 10, such as pivotally coupled to the middle portion 21 of the shank 13 with a pivot axle 42 for openably closing the compartment 14 of the hook member 10, another spring biasing member 43 is attached or engaged onto the pivot axle 42 and/or disposed between the latch member 40 and the shank 13 or the hook member 10 for biasing or forcing the latch member 40 to block or to close the compartment 14 of the hook member 10 (FIGS. 2-4), and arranged for allowing the compartment 14 of the hook member 10 to be selectively opened when the latch member 40 is depressed onto the spring biasing member 43 and forced or moved toward the shank 13 or the hook member 10 (FIG. 5). The latch member 40 includes an extension or anchor member 44 extended therefrom, such as extended from the lower or middle portion 45 thereof.

As shown in FIGS. 2-4, it is preferable that the lock member 34 of the hinged gate 30 and the anchor member 44 of the latch member 40 and the pivot axle 42 are aligned or inline with each other, and/or the anchor member 44 of the latch member 40 is arranged or disposed or engaged between the lock member 34 of the hinged gate 30 and the pivot axle 42 for locking the hinged gate 30 to the hook member 10 and for preventing the hinged gate 30 from being depressed or actuated onto the spring biasing member 33 and for preventing the hinged gate 30 from being forced or moved toward the shank 13 or the hook member 10 and thus for preventing the hook throat opening 11 of the hook member 10 from being opened inadvertently.

In operation, as shown in FIG. 5, when the latch member 40 is depressed or actuated onto the spring biasing member 43, the anchor member 44 of the latch member 40 may be moved or disengaged from the lock member 34 of the hinged gate 30, at this moment, the hinged gate 30 is released and may be depressed or actuated onto the spring biasing member 33 and may be forced or moved toward the shank 13 or the hook member 10 in order to open the hook throat opening 11 of the hook member 10 and for allowing the strap or the belt connection (not shown) to be disengaged from the hook throat opening 11 of the hook member 10.

As shown in FIGS. 2-4, when the latch member 40 is released, the latch member 40 will be biased by the spring biasing member 43 to block or to close the compartment 14 of the hook member 10, and to align the anchor member 44 of the latch member 40 and the pivot axle 42 with the lock member 34 of the hinged gate 30 and thus to lock the hinged gate 30 to the hook member 10 and in order to prevent the hinged gate 30 from being depressed or actuated or forced or moved toward the shank 13 or the hook member 10 and thus for preventing the hook throat opening 11 of the hook member 10 from being opened inadvertently.

The snap hook device further includes an eye device 5 having a ring or loop member 50, and a base ring 51 formed integral or attached or provided on the lower portion of the loop member 50, and the base ring 51 includes a bore 52 formed therein for pivotally or rotatably receiving or coupling or engaging with the stem 16 of the hook member 10, and includes a peripheral recess or shoulder 53 formed or provided therein and communicating with the bore 52 of the base ring 51 for engaging with the ball bearing device 20 and for rotatably and smoothly coupling the loop member 50 of the eye device 5 to the stem 16 of the hook member 10. A gasket 55 is engaged into the bore 52 of the base ring 51 and engaged with the ball bearing device 20 for stably anchoring and positioning the ball bearing device 20 between the stem 16 of the hook member 10 and the base ring 51 of the eye device 5.

The gasket 55 includes a bore 56 formed therein for pivotally or rotatably receiving or coupling or engaging with the stem 16 of the hook member 10, and includes a peripheral flange 57 extended radially and outwardly therefrom for engaging with the base ring 51 of the eye device 5 and for further stably anchoring and positioning the ball bearing device 20 between the stem 16 of the hook member 10 and the base ring 51 of the eye device 5. A ring-shaped spring biasing member or a spring ring 60 includes an opening 61 formed therein for receiving or engaging with the stem 16 of the hook member 10, and includes another circular or peripheral indicating layer 62 formed or provided around the outer peripheral portion of the spring ring 60, and includes a high-visibility color different from that of the gasket 55 and offered as an increased visual aid to verify whether the spring ring 60 has been compressed or deformed or damaged or not.

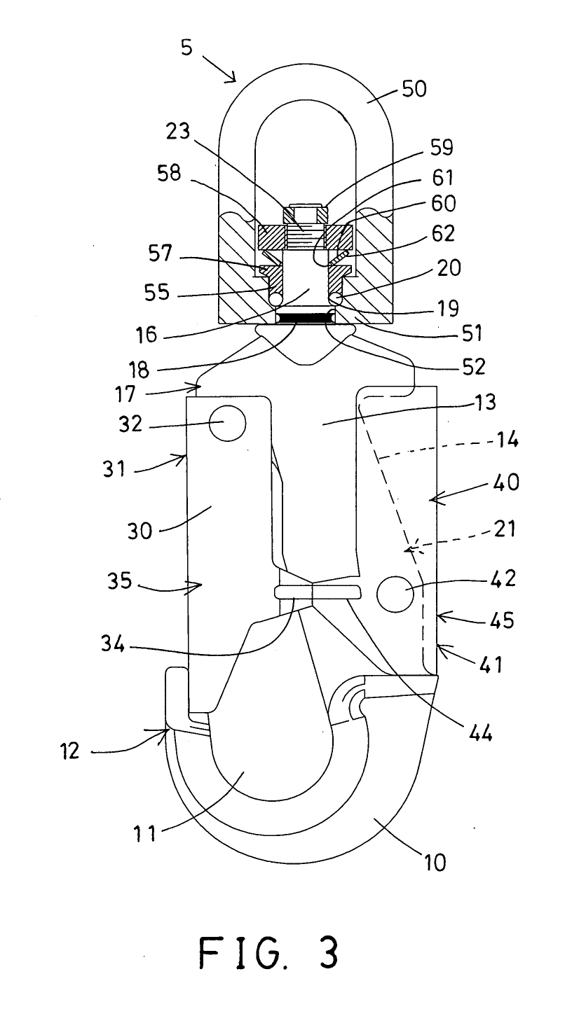

A lock nut 58 is threaded or engaged with the threaded segment 23 of the stem 16 and engaged with the spring ring 60 and arranged for allowing the spring ring 60 to be maintained in an upwardly extended status or in an upwardly inclined status as shown in FIGS. 3 and 4, and for allowing the spring ring 60 to provide a spring biasing force between the gasket 55 and the stem 16 and the lock nut 58. It is preferable that the eye device 5 further includes a head or lock ring 59 riveted or secured to the upper portion of the stem 16 for solidly maintaining or locking or securing the lock nut 58 to the stem 16 and for preventing the lock nut 58 from being disengaged from the stem 16, and thus for resiliently coupling or securing or locking the base ring 51 of the eye device 5 to the stem 16 of the hook member 10.

In operation, as shown in FIG. 5, when the spring ring 60 is still in good order or has not been compressed or deformed or damaged, the spring ring 60 may be maintained in the upwardly extended or inclined status for allowing the indicating layer 62 formed or provided around the outer peripheral portion of the spring ring 60 to be seen by the users, and for allowing the high-visibility color of the indicating layer 62 to offer as an increased visual aid to verify whether the spring ring 60 has been compressed or deformed or damaged or not. At this moment, the indicating layer 18 of the stem 16 will be blocked or covered or shielded by the base ring 51 of the eye device 5 and may not be seen by the users.

When a great over weight has been applied to the hook member 10 and when the spring ring 60 may not sustain the weight, at this moment, the spring ring 60 will be deformed or damaged and compressed between the gasket 55 and the lock nut 58 of the stem 16, and the indicating layer 62 of the spring ring 60 may no longer be seen by the users, and the gasket 55 and the base ring 51 of the eye device 5 may be moved upwardly relative the stem 16 of the hook member 10, due to the compression of the spring ring 60, for allowing the indicating layer 18 of the stem 16 to be exposed and to be seen by the users, and for allowing the high-visibility color of the indicating layer 18 to offer as an increased visual aid to verify whether the spring ring 60 has been compressed or deformed or damaged or not, and for allowing the spring ring 60 to be changed or replaced with the new ones.

Accordingly, the safety snap hook device in accordance with the present invention includes a double locking structure for safely locking the snap hook device and for preventing the snap hook device from being opened inadvertently and for allowing the snap hook device to be easily manufactured and operated.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A snap hook device comprising:
a hook member including a hook throat opening formed therein and defined by a hook portion and a shank, and including a compartment formed therein and located opposite to said hook throat opening of said hook member,
a hinged gate pivotally coupled to said shank of said hook member with a pivot pin for openably closing said hook throat opening of said hook member,
a first spring biasing member disposed between said hinged gate and said shank of said hook member for biasing and forcing said hinged gate to close said hook throat opening of said hook member, and arranged to allow said hook throat opening of said hook member to be selectively opened when said hinged gate is depressed onto said spring biasing member and forced toward said shank of said hook member,
a latch member pivotally coupled to said shank of said hook member with a pivot axle for openably closing said compartment of said hook member, said latch member including an anchor member extended therefrom, and
a second spring biasing member disposed between said latch member and said shank of said hook member for biasing and forcing said latch member to close said compartment of said hook member, and arranged for allowing said compartment of said hook member to be selectively opened when said latch member is depressed onto said spring biasing member and forced toward said shank of said hook member, said second spring biasing member being provided for biasing and forcing said anchor member of said latch member to engage with said hinged gate and to lock said hinged gate to said hook member, and to prevent said hinged gate from being depressed and actuated and forced toward said shank of said hook member and to prevent said hook throat opening of said hook member from being opened inadvertently before said anchor member of said latch member is disengaged from said hinged gate.

2. The snap hook device as claimed in claim 1, wherein said hinged gate includes a lock member extended therefrom for selectively engaging with said anchor member of said latch member and for selectively locking said hinged gate to said hook member.

3. The snap hook device as claimed in claim 2, wherein said lock member of said hinged gate and said anchor member of said latch member and said pivot axle are aligned with each other, and said anchor member of said latch member is disposed between said lock member of said hinged gate and said pivot axle for locking said hinged gate to said hook member.

4. The snap hook device as claimed in claim 1, wherein said hook member includes a stem extended upwardly from said shank, and an eye device rotatably coupled to said stem of said hook member.

5. The snap hook device as claimed in claim 4, wherein said eye device includes a loop member and a base ring provided on said loop member, and said base ring includes a bore formed therein for rotatably receiving and engaging with said stem of said hook member.

6. The snap hook device as claimed in claim 5, wherein said eye device includes a ball bearing device disposed between said base ring and said stem of said hook member for rotatably coupling said loop member of said eye device to said stem of said hook member.

7. The snap hook device as claimed in claim 6, wherein said eye device includes a gasket engaged into said bore of said base ring and engaged with said ball bearing device for anchoring said ball bearing device between said stem of said hook member and said base ring of said eye device.

8. The snap hook device as claimed in claim 7, wherein said eye device includes a spring ring having an opening formed therein for receiving and engaging with said stem of said hook member, and having a peripheral indicating layer provided around said spring ring, and said indicating layer includes a high-visibility color different from that of said gasket and offered as an increased visual aid to verify whether said spring ring has been compressed or not.

9. The snap hook device as claimed in claim 8, wherein said eye device includes a lock nut engaged with said stem and engaged with said spring ring for maintaining said spring ring in an upwardly extended and inclined status.

10. The snap hook device as claimed in claim 8, wherein said hook member includes a peripheral indicating layer provided around said stem and covered and shielded by said base ring before said spring ring is compressed, and said peripheral indicating layer of said hook member is exposed and to be seen by a user when said spring ring is compressed.
